(19) United States
(12) Patent Application Publication
(10) Pub. No.: US 2020/0258519 A1
(43) Pub. Date: Aug. 13, 2020

(54) ELECTRONIC APPARATUS, CONTROL DEVICE, CONTROL METHOD, AND NON-TRANSITORY COMPUTER READABLE RECORDING MEDIUM

(71) Applicant: SHARP KABUSHIKI KAISHA, Sakai City (JP)

(72) Inventors: YUSUKE KURIMOTO, Sakai City (JP); HIROSHI WADA, Sakai City (JP)

(21) Appl. No.: 16/788,118

(22) Filed: Feb. 11, 2020

(30) Foreign Application Priority Data
Feb. 13, 2019 (JP) 2019-023406

(51) Int. Cl. G10L 15/22; B25J 11/00; B25J 9/16

(52) U.S. Cl. CPC G10L 15/22; B25J 11/0005; G10L 2015/225; G10L 2015/223; B25J 9/1656

(57) ABSTRACT

Provided is an electronic apparatus including: at least one voice output device; and at least one control device, in which the control device performs completion detection processing of detecting that a predetermined action is completed, completion notification processing of notifying at least one service function, which is executed by the electronic apparatus, of completion of the action, association determination processing of determining whether or not a service function of providing service associated with the action is present, and voice output processing of, when the service function of providing the service is present, outputting voice data according to the service from the voice output device.

### BACKGROUND

### 1. Field

The present disclosure relates to an electronic apparatus, a control device, a control method, and a non-transitory computer readable recording medium.

### 2. Description of the Related Art

Systems that allow communication with a user by a conversation via an input and an output of voice have been recently used. Moreover, a technique that includes such a system and may provide more convenient service for a user by a robot that may perform an operation other than a conversation is also developed.

Such a robot starts to provide the service to the user in many cases when an instruction is given by the user. Accordingly, after certain interaction between the user and the robot ends, it is difficult to further continue a conversation and an opportunity to provide more service by the robot is missed. This leads to lowering of continuous usage of the robot.

As a countermeasure against such a problem, for example, Japanese Unexamined Patent Application Publication No. 2006-263858 discloses a technique by which two robots serially conduct communication behavior in such a manner that, in accordance with start or end of conducting communication behavior of one of the two robots, the robot transmits a timing to conduct communication behavior to the other robot.

In a related art as described above, however, communication is performed between the robots and scenario of the communication is limited in a given range. Thus, a content of a conversation lacks variation and a cooperative operation between applications, service, and the like that are built in the respective robots is not taken into consideration.

An aspect of the disclosure achieves an electronic apparatus, such as a robot, which is able to continuously provide a variety of service.

### SUMMARY

In order to deal with the aforementioned problem, an electronic apparatus according to an aspect of the disclosure is an electronic apparatus including: at least one voice output device; and at least one control device, in which the control device performs completion detection processing of detecting that a predetermined action is completed, completion notification processing of notifying at least one service function, which is executed by the electronic apparatus, of completion of the action, association determination processing of determining whether or not a service function of providing service associated with the action is present, and voice output processing of, when the service function of providing the service is present, outputting voice data according to the service from the voice output device.

In order to deal with the aforementioned problem, a control device according to an aspect of the disclosure is a control device that controls an electronic apparatus including at least one voice output device and executing at least one service function, and the control device includes: a completion detection unit that performs processing of detecting that a predetermined action is completed, a completion notification unit that performs processing of notifying the at least one service function of completion of the action, an association determination unit that performs processing of determining whether or not a service function of providing service associated with the action is present, and a voice output unit that performs processing of, when the service function of providing the service is present, outputting voice data according to the service from the voice output device.

In order to deal with the aforementioned problem, a control method according to an aspect of the disclosure is a control method by which an electronic apparatus including at least one voice output device and executing at least one service function is controlled, and the control method includes: detecting that a predetermined action is completed, notifying the at least one service function of the completion of the action, determining whether or not a service function of providing service associated with the action is present, and outputting voice data according to the service from the voice output device when the service function of providing the service is present.

### BRIEF DESCRIPTION OF THE DRAWINGS

FIG. 1 is a block diagram illustrating a functional configuration of an electronic apparatus according to Embodiment 1;

FIG. 2 is a flowchart illustrating an example of a flow of processing by a control device according to Embodiment 1;

FIG. 3 is a flowchart illustrating an example of a flow of processing by the control device according to Embodiment 1;

FIG. 4 illustrates an example of a conversation by the electronic apparatus according to Embodiment 1;

FIG. 5 illustrates an example of a conversation by the electronic apparatus according to Embodiment 1;

FIG. 6 illustrates an example of a conversation by the electronic apparatus according to Embodiment 1; and

FIG. 7 illustrates an example of a conversation by an electronic apparatus according to Embodiment 2.

### DESCRIPTION OF THE EMBODIMENTS

### Embodiment 1

### (Functional Configuration of Electronic Apparatus 1)

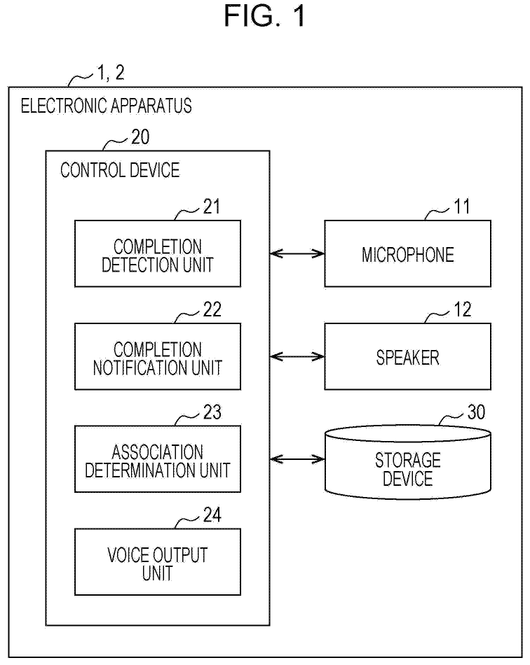

An embodiment of the disclosure will be described below with reference to FIGS. 1 to 6. As illustrated in FIG. 1, an electronic apparatus 1 according to the present embodiment includes a microphone 11, a speaker (voice output device) 12, a control device 20, and a storage device 30. The electronic apparatus 1 is desirably a robot capable of having a conversation with a user, but is not limited thereto, and may be, for example, a smartphone or the like which has a conversation function.

The microphone 11 is a member that inputs voice from the user. The microphone 11 may be an audio collection device such as an existing and general microphone. The microphone 11 converts the input voice into an electric signal and outputs the resultant to the control device 20. The control device 20 may perform voice recognition for the input voice and then discriminate instruction contents from the user. Note that, the voice recognition for the input voice may be performed not by the control device 20 but by, for example, a member that is provided in the electronic apparatus 1 exclusively for the voice recognition. Moreover, the voice recognition may be performed by an existing and general voice recognition technique.

According to an aspect in which an instruction is input to the electronic apparatus 1 by voice of the user in this manner, the user is able to easily give an instruction only by talking to the electronic apparatus 1. Note that, the input to the electronic apparatus 1 from the user is not limited to be performed with use of the voice but may be performed with use of a touch panel, a keyboard, or the like or with use of, for example, recognition of movement (gesture) of the user by a camera or the like. According to such a configuration, the user is able to give an instruction to the electronic apparatus 1 even in a situation, such as a quiet public space, in which it is difficult to speak.

The speaker 12 is a member that outputs voice from the electronic apparatus 1. The speaker 12 may be an existing and general voice output device. The electronic apparatus 1 recognizes an instruction of the user with use of the voice or the like of the user, which is input via the microphone 11, and provides service with use of the voice via the speaker 12, and thereby achieves the conversation function between the electronic apparatus 1 and the user.

### (Control Device 20)

The control device 20 is, for example, a central processing unit (CPU), and integrally controls each unit of the electronic apparatus 1. The control device 20 includes a completion detection unit 21, a completion notification unit 22, an association determination unit 23, and a voice output unit 24.

The completion detection unit 21 performs processing (completion detection processing) of monitoring a state of a service function that is currently executed by the electronic apparatus 1 and detecting that a last action (predetermined action) of service performed by the service function is completed. Examples of the service function include a program and an application that implement service that is able to be performed by the electronic apparatus 1.

The completion notification unit 22 performs processing (completion notification processing) of, when the completion detection unit 21 detects completion of the last action, notifying at least one service function, which is able to be executed by the electronic apparatus 1, of the completion of the action together with a service content including the action. At this time, the completion notification unit 22 may perform the notification to all service functions of the electronic apparatus 1 or may perform the notification only to part of the service functions. Part of the service functions may be, for example, a service function associated in advance with service that includes the completed action or the predetermined number of service functions selected on the basis of previous use frequency.

The association determination unit 23 performs processing (association determination processing) of determining whether or not there is a service function capable of providing service associated with the action among the service functions receiving the notification from the completion notification unit 22. For example, when a service function receiving the notification is able to provide service, the service function may notify the association determination unit 23 that the service function is able to provide service, and upon the notification, the association determination unit 23 may determine that there is a service function capable of providing service.

Further, in a case where there are a plurality of service functions capable of providing service, the association determination unit 23 may perform processing of selecting, from among them, a service function capable of providing service most closely associated with the service that includes the completed action. According to such a configuration, the electronic apparatus 1 is able to continuously provide service that the user is deeply interested in.

Further, in the case where there are a plurality of service functions capable of providing service, the association determination unit 23 may decide priority order of service functions in advance and perform processing of selecting a service function in accordance with the priority order. According to such a configuration, the electronic apparatus 1 is able to manage and control service provided to the user.

In a case where there is a service function capable of providing service that is determined to be associated service by the association determination unit 23, the voice output unit 24 performs processing (voice output processing) of causing the speaker 12 to output voice data according to the service.

According to the foregoing configuration, the control device 20 is able to cause the electronic apparatus 1, after single service by the electronic apparatus 1 is completed, to successively provide closely associated service. Accordingly, the electronic apparatus 1 is able to continuously provide service that the user is considered to be interested in. Further, by selecting service to be provided from among various service functions, the electronic apparatus 1 is able to provide a variety of service to the user.

Note that, the control device 20 may be provided in the electronic apparatus 1, or may be provided in a cloud server. In the latter case, a communication device (not illustrated) provided in the electronic apparatus 1 may transmit voice of the user to the control device 20 in the cloud server. In this case, the control device 20 in the cloud server may perform each processing described above on the basis of the voice and transmit voice data, which is to be output by the voice output unit 24, to the electronic apparatus 1. According to such a configuration, it is not necessary for the electronic apparatus 1 to include the control device 20, and the electronic apparatus 1 is able to be manufactured at a low cost. Moreover, the control device 20 that has higher performance than that of the control device 20 provided in the electronic apparatus 1 is able to be provided in the cloud server.

### (Storage Device 30)

The storage device 30 is a member that stores a program by which various service functions provided in the electronic apparatus 1 are executed, information input by the user, or the like. Examples of the storage device 30 include a hard disk drive (HDD), a solid state drive (SSD), and a read only memory (ROM). Moreover, the storage device 30 may further include, for example, a random access memory (RAM) which develops the program or the like.

### (Example of Processing by Control Device 20)

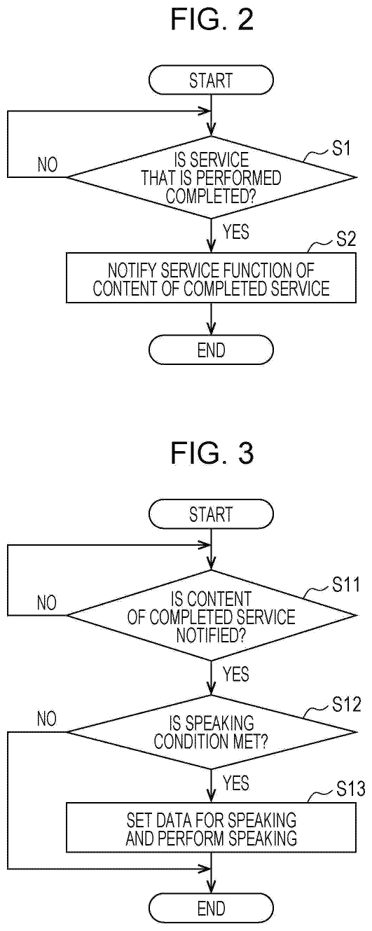

An example of processing (control method) performed by the control device 20 will be described below with reference to FIGS. 2 and 3. As illustrated in FIG. 2, the completion detection unit 21 monitors a state of a service function that is currently executed by the electronic apparatus 1 and determines whether or not a last action of service performed by the service function is completed (service is completed) (S1, completion detection step). The completion detection unit 21 continues monitoring until completion of the action is detected (NO at S1).

When the completion detection unit 21 detects completion of the service (YES at S1), the completion notification unit 22 notifies one or more service functions provided in the electronic apparatus 1 of a content of the completed service (completion notification step) (S2).

Next, as illustrated in FIG. 3, first, the association determination unit 23 determines whether or not the content of the completed service is notified from the completion notification unit 22 (S11, association determination step). The association determination unit 23 continues the determination until the notification is performed (NO at S11). When the notification is performed by the completion notification unit 22 (YES at S11), the association determination unit 23 determines whether or not there is a service function capable of providing service associated with the content of the completed service (whether or not a speaking condition is met) (S12).

In a case where there is no service function capable of providing service associated with the content of the completed service, the association determination unit 23 determines that there is no service to be provided successively and ends processing (NO at S12). On the other hand, in a case where there is a service function capable of providing service associated with the content of the completed service, the association determination unit 23 determines that the speaking condition by the electronic apparatus 1 is satisfied (YES at S12).

Next, the voice output unit 24 sets voice data according to the associated service and speaks to the user with use of the voice data by the speaker 12 (S13, voice output step). Here, the voice data according to the associated service may be set when the voice output unit 24 refers to a data table in which voice data that is linked to a service function providing the service and that corresponds to each service content is stored. Moreover, artificial intelligence (AI) may be incorporated in the electronic apparatus 1, the artificial intelligence may generate appropriate voice data corresponding to service to be provided, and the voice output unit 24 may set the generated voice data as the voice data according to the associated service.

As above, a series of processing of the control device 20 ends, but when a last action of service performed at and after step S13 is completed, the control device 20 may start the series of processing again from step S1. As a result, the electronic apparatus 1 is able to continuously provide service that the user is considered to be interested in.

### (Examples of Service Provided by Electronic Apparatus 1)

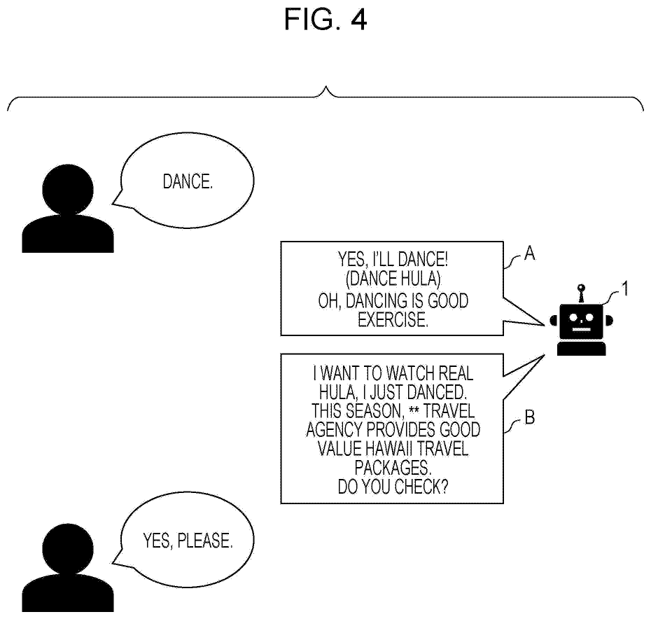

Examples of service provided by the electronic apparatus 1 will be described with reference to FIGS. 4 to 6. In the present embodiment, service including an action whose completion is detected by the completion detection unit 21 and service successively performed after the completed action are provided by different service functions.

For example, as illustrated in FIG. 4, when the user instructs the electronic apparatus 1 to dance, the electronic apparatus 1 executes a service function of a dance. The electronic apparatus 1 performs an action A of dancing and transmitting, to the user, that the dance is completed with use of voice, and completes the execution of the service function of the dance. Here, the control device 20 determines that a service function of a travel is able to provide service associated with the service (action A) of the dance and causes the electronic apparatus 1 to perform service B of proposing a travel by the service function of the travel. Thereby, the user is able to have an opportunity to search for travel information associated with a hula.

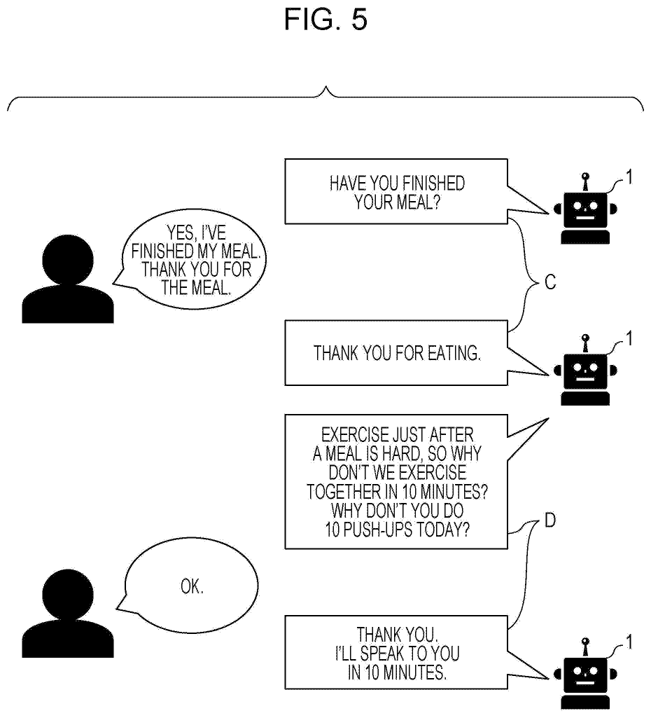

Moreover, as illustrated in FIG. 5, in a case of executing a service function of a meal, the electronic apparatus 1 performs an action C of checking completion of a meal by the user, and, after confirming completion of the meal, completes the execution of the service function of the meal. Here, the control device 20 determines that a service function of health care is able to provide service associated with service (action C) of checking completion of the meal and causes the electronic apparatus 1 to perform service D of proposing exercise after the meal by the service function of the health care. Thereby, the user is able to have an opportunity to take moderate exercise after the meal.

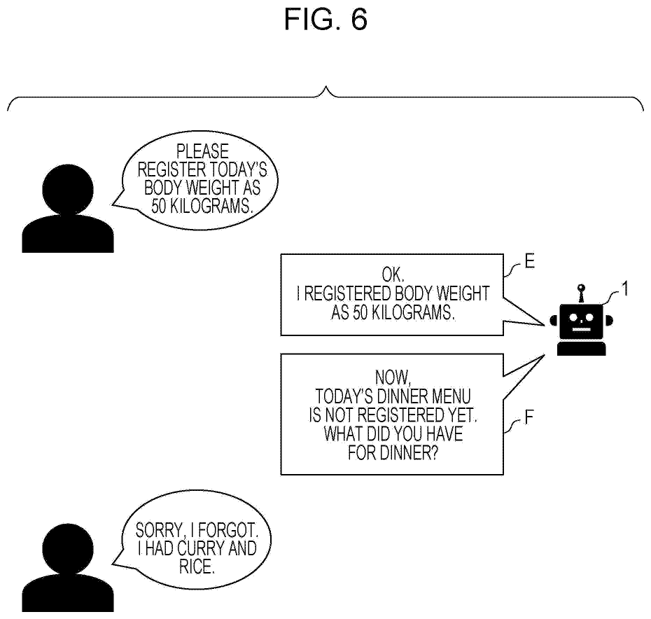

Moreover, as illustrated in FIG. 6, in a case of executing a service function of body weight control, the electronic apparatus 1 performs an action E of registering a body weight of the user and completes the execution of the service function of the body weight control. Here, the control device 20 determines that the service function of the meal is able to provide service associated with service (action E) of registering body weight and causes the electronic apparatus 1 to perform service F of registering a meal menu. Thereby, the user is able to have an opportunity to perform registration of a meal menu, which is forgotten by the user.

As described above, the electronic apparatus 1 according to the present embodiment is able to continuously provide service that the user is interested in. As a result, the user is able to have, for example, an opportunity to satisfy his or her potential interest and is also able to receive, from the electronic apparatus 1, a timely reminder related to a task that is forgotten.

Moreover, according to a configuration in which single service and service which is successively performed after completion of the single service are provided by different service functions, the electronic apparatus 1 is able to provide a variety of service to the user. Further, the electronic apparatus 1 is able to provide the user with an opportunity to utilize a service function that is not grasped or not efficiently used by the user.

### Embodiment 2

Another embodiment of the disclosure will be described below. Note that, for convenience of description, a member having the same function as that of the member described in the aforementioned embodiment will be given the same reference sign and description thereof will not be repeated.

An electronic apparatus 2 according to the present embodiment is different from the electronic apparatus 1 according to Embodiment 1 in that both an action whose completion is detected by the completion detection unit 21 and service successively performed after the completed action are provided by the same service function.

The completion notification unit 22 performs processing (completion notification processing) of, when the completion detection unit 21 detects completion of an action, notifying at least one service function, which is able to be executed by the electronic apparatus 2, of the completion of the action together with a service content including the action. At this time, the service function for which the notification is performed may include a service function that provides service including the completed action.

After the completion detection unit 21 detects the completion of the action, the association determination unit 23 may determine whether or not a service function that is the same as the service function that provides the service including the action is able to successively provide service. Moreover, in a case where there are a plurality of service functions capable of providing service, the association determination unit 23 may perform processing of selecting, from among them, the same service function as a service function that is most closely associated with the completed action.

According to such a configuration, the association determination unit 23 is able to select a most suitable service function for successively providing service from among service functions also including a service function that provides service including a completed action. Further, in a case where a service function that provides completed service once further provides associated service, these two pieces of associated service are able to be seamlessly provided.

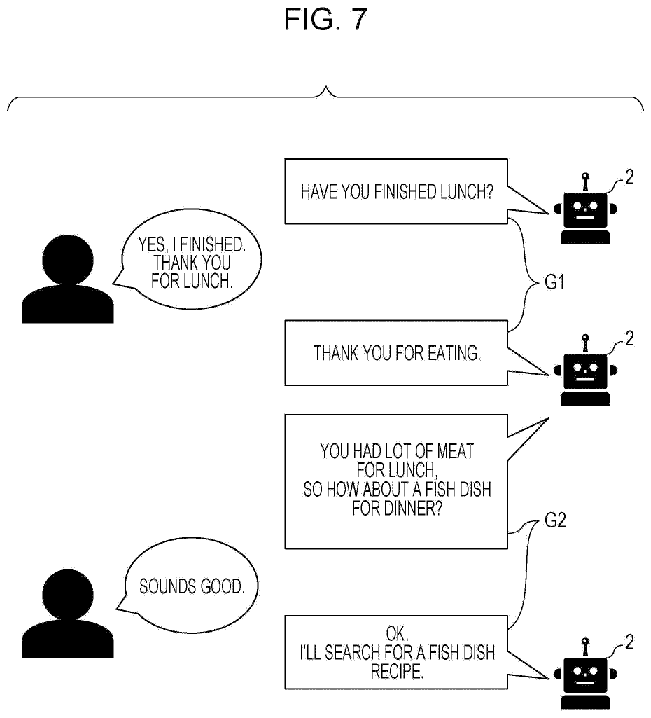

For example, as illustrated in FIG. 7, in a case of executing a service function of a meal, the electronic apparatus 2 performs an action G1 of checking completion of a meal by the user, and, after confirming completion of the meal, completes the execution of the service function of the meal. Here, the control device 20 determines that the service function of the meal is able to further provide service and causes the electronic apparatus 2 to successively perform service G2 of proposing a next meal menu. Thereby, the electronic apparatus 2 is able to provide the user with diversified and detailed service by the same service function.

### [Implementation Example by Software]

Control blocks (particularly, the completion detection unit 21, the completion notification unit 22, the association determination unit 23, and the voice output unit 24) of the control device 20 may be implemented by a logic circuit (hardware) formed in an integrated circuit (IC chip) or the like or may be implemented by software.

In the latter case, the control device 20 includes a computer that executes a command of a program that is software implementing each function. The computer includes, for example, at least one processor (control device) and at least one computer-readable recording medium that stores the program. When the processor reads the program from the recording medium and executes the program in the computer, the disclosure is implemented. As the processor, for example, a central processing unit (CPU) is able to be used. As the recording medium, a “non-transitory tangible medium”, for example, such as a tape, a disk, a card, a semiconductor memory, or a programmable logic circuit is able to be used in addition to a read only memory (ROM) and the like. Moreover, a random access memory (RAM), which develops the program, or the like may be further included. Further, the program may be supplied to the computer via any transmission medium (such as a communication network or a broadcast wave) which allows the program to be transmitted. Note that, an aspect of the disclosure may also be implemented in a form of a data signal in which the program is embodied through electronic transmission and which is embedded in a carrier wave.

### CONCLUSION

An electronic apparatus according to an aspect 1 of the disclosure is an electronic apparatus including: at least one voice output device; and at least one control device, in which the control device performs completion detection processing of detecting that a predetermined action is completed, completion notification processing of notifying at least one service function, which is executed by the electronic apparatus, of completion of the action, association determination processing of determining whether or not a service function of providing service associated with the action is present, and voice output processing of, when the service function of providing the service is present, outputting voice data according to the service from the voice output device.

In the electronic apparatus according to an aspect 2 of the disclosure, the action and the service may be provided by service functions different from each other in the aspect 1.

In the electronic apparatus according to an aspect 3 of the disclosure, the service function may provide both the action and the service in the aspect 1.

A control device according to an aspect 4 of the disclosure is a control device that controls an electronic apparatus including at least one voice output device and executing at least one service function, and the control device includes: a completion detection unit that performs processing of detecting that a predetermined action is completed, a completion notification unit that performs processing of notifying the at least one service function of completion of the action, an association determination unit that performs processing of determining whether or not a service function of providing service associated with the action is present, and a voice output unit that performs processing of, when the service function of providing the service is present, outputting voice data according to the service from the voice output device.

A control method according to an aspect 5 of the disclosure is a control method by which an electronic apparatus including at least one voice output device and executing at least one service function is controlled, and the control method includes: detecting that a predetermined action is completed, notifying the at least one service function of the completion of the action, determining whether or not a service function of providing service associated with the action is present, and outputting voice data according to the service from the voice output device when the service function of providing the service is present.

The control device according to each of the aspects of the disclosure may be implemented by a computer. In this case, a control program of the control device, which causes the computer to operate as each unit (software element) included in the control device to thereby achieve the control device by the computer, and a non-transitory computer readable recording medium that records the control program are also encompassed in the scope of the disclosure.

### ADDITIONAL MATTER

The disclosure is not limited to each of the embodiments described above and may be modified in various manners within the scope indicated in the claim, and an embodiment achieved by appropriately combining techniques disclosed in each of different embodiments is also encompassed in the technical scope of the disclosure. Further, by combining the techniques disclosed in each of the embodiments, a new technical feature may be formed.

The present disclosure contains subject matter related to that disclosed in Japanese Priority Patent Application JP 2019-023406 filed in the Japan Patent Office on Feb. 13, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus comprising: at least one voice output device; and at least one control device, wherein
the control device performs
completion detection processing of detecting that a predetermined action is completed,
completion notification processing of notifying at least one service function, which is executed by the electronic apparatus, of completion of the action,
association determination processing of determining whether or not a service function of providing service associated with the action is present, and
voice output processing of, when the service function of providing the service is present, outputting voice data according to the service from the voice output device.

2. The electronic apparatus according to claim 1, wherein the action and the service are provided by service functions different from each other.

3. The electronic apparatus according to claim 1, wherein the service function provides both the action and the service.

4. A control device that controls an electronic apparatus including at least one voice output device and executing at least one service function, the control device comprising:
a completion detection unit that performs processing of detecting that a predetermined action is completed,
a completion notification unit that performs processing of notifying the at least one service function of completion of the action,
an association determination unit that performs processing of determining whether or not a service function of providing service associated with the action is present, and
a voice output unit that performs processing of, when the service function of providing the service is present, outputting voice data according to the service from the voice output device.

5. A control method by which an electronic apparatus including at least one voice output device and executing at least one service function is controlled, the control method comprising:
detecting that a predetermined action is completed,
notifying the at least one service function of the completion of the action,
determining whether or not a service function of providing service associated with the action is present, and
outputting voice data according to the service from the voice output device when the service function of providing the service is present.

6. A non-transitory computer readable recording medium that records a control program by which a computer is caused to execute each process according to claim 5.
